(19) United States
(12) Patent Application Publication
(10) Pub. No.: US 2009/0243459 A1
(43) Pub. Date: Oct. 1, 2009

(54) DISCHARGE LAMP, IN PARTICULAR LOW PRESSURE DISCHARGE LAMP

(76) Inventor: Holger Hein, Augsburg (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/309,933

(22) PCT Filed: Aug. 7, 2007
(86) PCT No.: PCT/EP2007/058191

§ 371 Date: Feb. 3, 2009

(30) Foreign Application Priority Data
Aug. 10, 2006 (DE) 10-2006-037-550.5

(51) Int. Cl. H01J 61/52

(52) U.S. Cl. 313/46

(57) ABSTRACT

The invention relates to a discharge lamp, in particular a low pressure discharge lamp, with a discharge vessel (2) and a tubular piece (6) that is attached to the discharge vessel (2), with an Hg source (7) arranged in the tubular piece, and a cooling device (8) designed on the tubular piece (6) for dissipating the heat of at least the tubular piece that heats up during the operation of the discharge lamp (I).

### TECHNICAL FIELD

The invention relates to a discharge lamp, in particular a low pressure discharge lamp, having a discharge vessel and a tubular piece that is attached to the discharge vessel and in which an Hg source is arranged.

### PRIOR ART

Particularly in the form of compact fluorescent lamps, gas discharge lamps have been widely used for some time. In this case, both gas discharge lamps with integrated electronic ballast, or else for connection to a separate electronic ballast are common. Conventional discharge lamps have a mostly liquid mercury source (Hg source) from which a suitable quantity of mercury evaporates during operation, the Hg vapor being excited by electron impact and leading to the generation of UV radiation. Here, the term Hg source basically comprises two functions in principle, specifically that of an Hg donor, on the one hand. This is a material or a body in which the mercury is contained. Furthermore, there is, however, also a vapor pressure controlling Hg compound, such as amalgams, for example, designed independently thereof. A vapor pressure controlling element and, in particular, an amalgam are required in order to produce defined conditions for the vapor pressure of the mercury that prevails during operation. The temperature of the vapor pressure controlling element controls the vapor pressure of the mercury in the discharge.

It is also known to provide in the region of the discharge tube ends exhaust tube attachments that are thin in relation thereto and, on the one hand, serve as exhaust tubes in the production of the gas discharge lamp, that is to say serve to evacuate and fill the discharge vessel, and, on the other hand, frequently also hold the Hg source. The latter is thus accommodated in a thinner tube attachment that protrudes from one of the discharge tube ends. This tube attachment can, for example, extend into a housing of the discharge lamp in which the electronic ballast is also arranged.

A discharge lamp in the case of which the discharge vessel is of helical design and is connected to a housing in which an integrated electronic ballast is arranged is disclosed in DE 10 2004 018 104 A1.

There are known among energy saving lamps types with such an Hg source that are designed for relatively high temperatures at the location of the Hg source, and this can be the case for high ambient temperatures. The fact that the amalgam controls the mercury vapor pressure also means that it controls the photoelectric values such as power, luminous flux and efficiency of the discharge lamp. In known compact fluorescent lamps, the problem can arise that the temperature of the working amalgam is too high, resulting in a worsening of the photoelectric values. It is known that either the amalgam alloy is adapted or another insertion location is selected in order to reduce this problem with an excessively high amalgam temperature. However, this is mostly very complicated and facilitates only a conditional improvement.

### SUMMARY OF THE INVENTION

It is therefore an object of the present invention to provide a discharge lamp in the case of which the temperature of the Hg source can also be more effectively controlled, particularly given relatively high ambient temperatures.

This object is achieved by a discharge lamp that has the features according to patent claim 1.

An inventive discharge lamp, in particular a low pressure discharge lamp, comprises a discharge vessel and a tubular piece that is attached to the discharge vessel and in which an Hg source, in particular in the form of an Hg amalgam, is arranged. A cooling device for dissipating the heat at least of the tubular piece that heats up during operation of the discharge lamp is constructed on the tubular piece. This integrated arrangement of a cooling device on the tubular piece can also facilitate a substantially improved temperature control of the Hg source in the case of discharge lamps that are also operated at relatively hot ambient temperatures. The fact that the dissipation of the heat of the tubular piece is controlled means that it is also possible to control the temperature of the Hg source located in the tubular piece. In particular, an optimum cooling can take place in the case of relatively hot temperatures of the amalgam or of the Hg source.

The cooling device integrated in the discharge lamp can be arranged such that the dimensions of the discharge lamp remain unchanged or substantially unchanged. The compactness of the discharge lamp is thereby not impaired by this additional cooling device.

It is preferred to arrange the cooling device at a first end of the tubular piece averted from the discharge vessel.

The cooling device preferably comprises a heat sink that is designed, in particular, in a meandering fashion. It can be provided that the heat sink is designed as a wound metal strip. This meandering structure of the heat sink enables a compact and space saving design and yet a surface of the heat dissipation that is provided in a relatively large fashion. The cooling power can be defined by the length of the meandering heat sink or by another geometry, and the position of the maximum luminous flux can thereby be controlled.

The meandering heat sink is preferably arranged substantially between two opposite end regions of the discharge vessel.

The discharge vessel can preferably be of helical design, and the two end regions of this helical shape are preferably oriented in one direction. Also are possible are other forms of the discharge vessel such as 3-tube lamps that have, for example, three tubes which are curved in a U-shaped fashion and are connected via attachments to a coherent discharge vessel, said lamps having an Hg source in the exhaust tube attached to the discharge vessel. This meandering heat sink can also be arranged at least partially inside this helical shape. It is likewise possible to provide that the cooling device is arranged at least partially in a housing into which there extend the end regions of the discharge vessel and the first end of the tubular piece. In particular, the heat sink of this cooling device can be located at least partially in this housing. It can also be provided that an integrated ballast of the discharge lamp is arranged in the housing. The meandering configuration of the heat sink can preferably be arranged in the middle between the end regions of the discharge vessel.

Such a centering enables as wide a spacing as possible from neighboring components of the discharge lamp. The end region of the discharge vessel facing the housing can be covered by a cover cap.

It can be provided that the discharge lamp has a jacket that surrounds the discharge vessel. In such a design, the cooling device can be arranged at least partially between the jacket and the discharge vessel.

The inventive discharge lamp is designed such that ambient temperatures in the region of the Hg source can occur at up to approximately 150° C. Since there is a maximum operating temperature range of up to approximately 135° C. for high temperature amalgams, as well, this cooling device can achieve an appropriate cooling for such relatively hot ambient temperatures, and a substantially improved control of the mercury vapor pressure can be achieved by the amalgam at such high ambient temperatures, as well.

The cooling device preferably comprises an annular insulation element for electrical insulation that is arranged on the tubular piece with the amalgam and on which the heat sink is arranged or fastened. The insulation element is preferably arranged bearing against an end region of the discharge vessel. The stable positioning and arrangement can thereby be ensured.

The opening provided in the insulation element for guiding through the tubular piece is preferably designed such that a relative movement can be carried out between the tubular piece and the insulation element in a direction perpendicular to the opening axis. It can be provided that this opening is of oval design. The opening can likewise be configured as an elongated hole. The insulation element is preferably positioned in the housing of the discharge lamp. It can be provided that the insulation element is integrated in the cover cap, which is preferably fastened releasably on the end region of the discharge vessel facing the housing.

It can also be provided that supply leads are guided through the opening of the insulation element to an electrode, in particular a lamp filament, in the discharge lamp. The insulation element can be used for multiple functions in this context, and also serves to hold these supply leads stably. Owing to the configuration as an electrically insulating element, it is also possible for the conduction of current to be kept away in a defined fashion from the heat sink which is, in particular, of metal design. The insulation element can be made of plastic. It can be provided to use a highly thermally conductive, highly electrically insulating material. By way of example, the insulation element can be designed at least partially from oxide ceramic, in particular aluminum oxide.

An end web of the heat sink is preferably guided in a guide rail of the insulation element at a spacing from the supply leads. The cooling device, in particular the heat sink, can at least partially make contact with a thermally conductive adhesive or a thermally conductive paste. The heat transport can thereby be improved once again.

It is possible by means of the proposed discharge lamp to maintain a relatively good starting performance of amalgams with a low operating temperature range such as, for example, a Biln₃₂Hg₄ amalgam. Moreover, it is possible to achieve a luminous flux of over 90% in a temperature range between approximately 66° C. and approximately 82° C. Moreover, a possibility can be achieved of shifting the luminous flux maximum to, or in the direction of, a particular temperature, from low temperatures.

Owing to the fact that the opening in the insulation element is designed with a larger diameter than the diameter of the tubular piece, it becomes possible to compensate tolerances of the burner of the discharge lamp.

### BRIEF DESCRIPTION OF THE DRAWING(S)

An exemplary embodiment of the invention is explained in more detail below with the aid of schematics. In the drawing:

FIG. 1 shows a schematic of an inventive discharge lamp;

FIG. 2 shows a perspective illustration of a subregion of an inventive discharge lamp;

FIG. 3 shows a first view of a subregion of the inventive discharge lamp; and

FIG. 4 shows a second subregion of an inventive discharge lamp showing a perspective illustration.

### PREFERRED DESIGN OF THE INVENTION

Identical or functionally identical elements are provided in the figures with identical reference numerals.

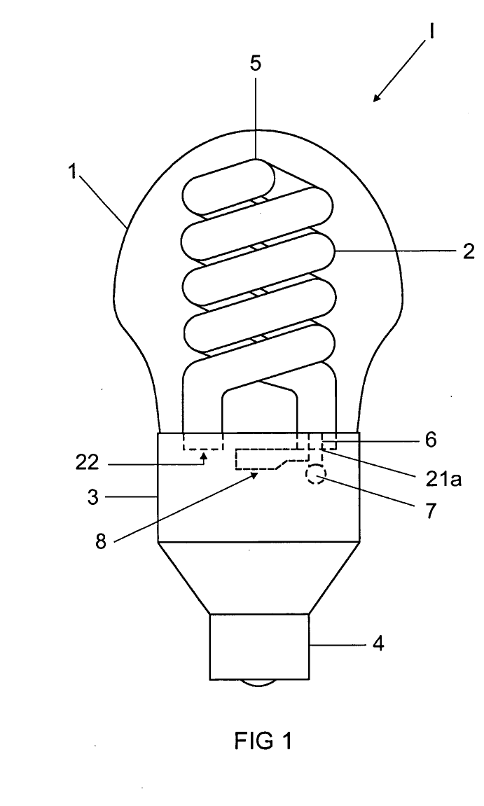

FIG. 1 shows a discharge lamp I that is designed as a compact fluorescent lamp and has a jacket 1. The jacket 1 encloses a helically wound discharge vessel 2. The tubular and helically wound discharge vessel 2 is connected to an electronic ballast indicated only by its housing 3. The jacket 1 is also fastened on this housing 3 by latching elements.

On the side opposite the jacket 1, the housing 3 of the ballast ends in a standardized lamp base 4. In the exemplary embodiment, the discharge vessel 2 is assembled from two wound discharge tubular parts that merge into one another in a region 5.

The two ends 21 and 22 of the discharge vessel 2 are substantially opposite one another and arranged identically oriented in the direction of the housing 3. As is to be seen from the illustration in FIG. 1, these ends 21 and 22 extend into the housing 3. Attached to one end 21 is a tubular piece 6 designed as an exhaust tube. Provided in this tubular piece 6 is a vapor pressure controlling Hg source 7, for example an amalgam ball. A Biln₃₂Hg₄ amalgam is provided as Hg source 7 in the exemplary embodiment.

Further details familiar straightaway to the person skilled in the art, such as the electrodes, plate seals or pinches, are not shown here in more detail.

However, FIG. 1 makes plain that the exhaust tube attachment or the tubular piece 6 has a substantially smaller diameter than the discharge vessel 2 in this end 21. In fact, this tubular piece 6 is assigned a first electrode or a lamp filament in the first end 21. In addition, the tubular piece 6 on the one hand projects into the end 21, and on the other hand protrudes from the latter into the housing 3. It becomes clear from the illustration shown that the temperature of the Hg source 7 accommodated in the tubular piece 6 depends strongly on the ambient temperature in the housing 3, which is dependent in turn on the external ambient temperature, the heat input as a consequence of the power loss by the operating device and lamp body, the operating time and also on the installed position of the discharge lamp I.

The discharge lamp I furthermore comprises a cooling device 8 that is illustrated schematically in FIG. 1. In the exemplary embodiment, the cooling device 8 is arranged completely in the housing 3. As is to be seen, the cooling device 8 surrounds the tubular piece 6 and extends in the direction of the second end 22. In the exemplary embodiment, the cooling device 8 is positioned in a fashion substantially centered in the housing 3.

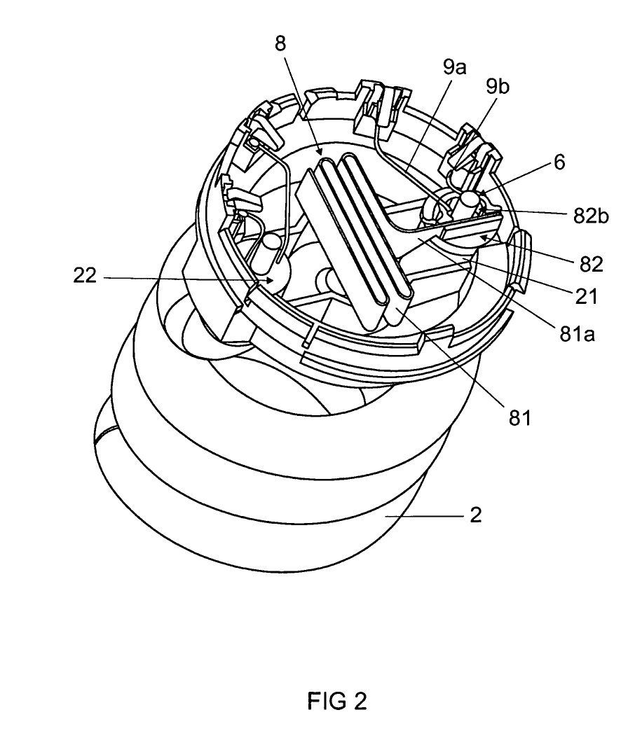

FIG. 2 shows a perspective illustration of the discharge vessel 2 and the cooling device 8. The housing 3 is removed in the rotated illustration, and the cooling device 8 is visible. The latter comprises a heat sink 81 that is designed as a meandering metal strip. One end 81a of this heat sink 81 is connected to an insulation element 82. As is to be seen, this end 81a is plugged into a guide rail 82a of this insulation element 82 and fastened therein. The annular insulation element 82 surrounds the tubular piece 6, and this tubular piece 6 projects through an opening 82b. In the exemplary embodiment, this opening 82b has an oval shape and is designed in a fashion similar to an elongated hole. The dimensions of this opening 82b are selected such that the outside diameter of the tubular piece 6 is smaller, and it is thereby possible to compensate tolerances of the burner of the discharge lamp I.

The insulation element 82 designed for electrical insulation lies directly on a surface 21a (FIG. 1) of the first end 21. This enables an arrangement in a stable position.

Similarly illustrated are supply leads 9a and 9b for a lamp filament extending at the first end 21 into the discharge vessel 2. The two supply leads 9a and 9b are guided through the opening 82b to the lamp filament. A conduction of current can be kept away in a defined fashion from the metallic heat sink 81 by the electrically insulating insulation element 82. In addition to the heat sink 81, it can be provided to improve the heat transport by means of a thermally conductive adhesive or a thermally conductive paste that is applied at least partially to the heat sink 81 and introduced between the tubular piece 6 and the end 81a.

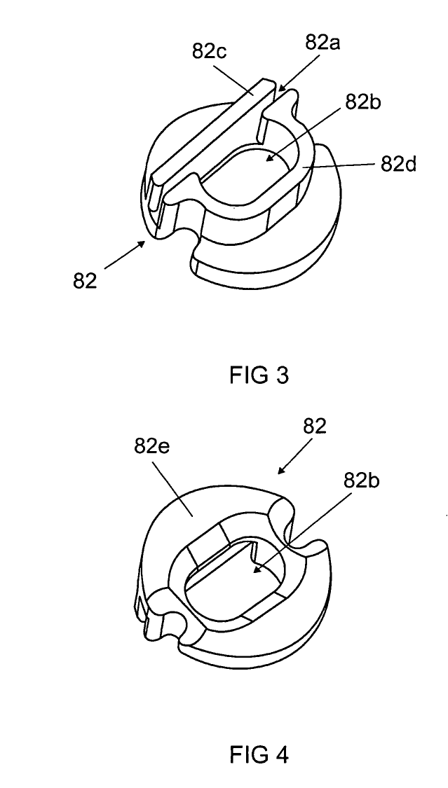

FIG. 3 shows a perspective view of the insulation element 2 in a plan illustration. It is to be seen that the guide rail 82a is formed by a long web 82c and end regions of an arcuate web 82d. The guide rail is arranged adjacent to the edge region of the opening 82b.

FIG. 4 shows a perspective illustration of the insulation element 82 from below. An underside 82e lies at least partially against the surface 21a (FIG. 1).

1. A discharge lamp, having a discharge vessel (2) and a tubular piece (6) that is attached to the discharge vessel (2) and in which an Hg source (7) is arranged, characterized in that a cooling device (8) for dissipating the heat at least of the tubular piece (6) that heats up during operation of the discharge lamp (1) is constructed on the tubular piece (6).

2. The discharge lamp as claimed in claim 1, characterized in that the cooling device (8) has a meandering heat sink (81).

3. The discharge lamp as claimed in claim 2, characterized in that the meandering heat sink (81) extends substantially between two opposite end regions (21, 22) of the discharge vessel (2).

4. The discharge lamp as claimed in one of the preceding claims, characterized in that the cooling device (8) is arranged at least partially in a housing (3) into which there extend the end regions (21, 22) of the discharge vessel (2) and the first end (61) of the tubular piece (6).

5. The discharge lamp as claimed in claim 1, characterized in that the discharge vessel (2) is surrounded by a jacket (1), and the cooling device (8) is arranged at least partially between the jacket (1) and the discharge vessel (2).

6. The discharge lamp as claimed in claim 1, characterized in that the cooling device (8) has an insulation element (82) for electrical insulation that is arranged on the tubular piece (6) and on which the heat sink (81) is arranged.

7. The discharge lamp as claimed in claim 6, characterized in that the insulation element (82) is arranged bearing against an end region (21) of the discharge vessel (2).

8. The discharge lamp as claimed in claim 6 or 7, characterized in that the opening (82b) provided in the insulation element (82) in order to guide through the tubular piece (6) is designed to be larger than the diameter of the tubular piece (6) in such a way that the tubular piece is arranged partially at a spacing from the edge of the opening (82b).

9. The discharge lamp as claimed in claim 7, characterized in that supply leads (9a, 9b) are guided through the opening (82b) of the insulation element (82) to an electrode, in particular a lamp filament, of the discharge lamp (I).

10. The discharge lamp as claimed in claim 6 or 7, characterized in that an end web (81a) of the heat sink (81) is guided in a guide rail (82a) of the insulation element (82) at a spacing from the supply leads (9a, 9b).

11. The discharge lamp as claimed in claim 1, characterized in that a thermally conductive adhesive or a thermally conductive paste is introduced at least partially between the tubular piece (6) and the cooling device (8), in particular the heat sink (81).

12. The discharge lamp as claimed in claim 1 which is a low pressure discharge lamp.
